(19) United States
(12) Patent Application Publication
(10) Pub. No.: US 2026/0242970 A1
(43) Pub. Date: Aug. 20, 2026

(54) LIQUID-LIQUID EXTRACTION SYSTEM FOR ELECTROACTIVE METAL ELECTRODEPOSITION FROM BRINE

(71) Applicant: Pure Lithium Corporation, Charlestown, MA (US)

(72) Inventors: Ketian ZHANG, Boston, MA (US); Michika ONODA, Cambridge, MA (US); Donald R. SADOWAY, Boston, MA (US); Sal BARRIGA, Charlestown, MA (US)

(21) Appl. No.: 19/348,433

(22) Filed: Oct. 2, 2025

Related U.S. Application Data
(63) Continuation of application No. PCT/US2024/023088, filed on Apr. 4, 2024.
(60) Provisional application No. 63/494,272, filed on Apr. 5, 2023.

(51) Int. Cl. C25D 3/42; B01D 61/24; B01D 61/28; C25D 17/00; H01M 4/04; H01M 4/1395; H01M 4/38

(52) U.S. Cl. CPC C25D 3/42; B01D 61/246; B01D 61/28; C25D 17/002; H01M 4/0452; H01M 4/1395; H01M 4/382

(57) ABSTRACT

Electrolytic systems and methods are described for extracting lithium cation from a brine and depositing purified lithium metal onto a conductive substrate to form lithium electrodes suitable for use in lithium metal batteries. The methods allow for selective extraction of lithium ions and electroplating the extracted lithium ions as lithium metal and lithium metal alloys.

### CROSS-REFERENCE

This application is a continuation application of International Application No. PCT/US2024/023088 filed Apr. 4, 2024, which claims priority to U.S. Provisional Application No. 63/494,272 filed Apr. 5, 2023, each of which application is incorporated herein by reference in its entirety.

### BACKGROUND

Lithium has good natural abundance but is diffusely distributed. Brine and seawater have significant amounts of lithium salts that could be harvested to provide lithium metal. However, in order to do so such salts must be concentrated and reduced to lithium metal.

Improved electrolytic methods are needed for the purification of lithium and other electroactive metals from dilute sources, the production of smooth, high-purity lithium metal and lithium metal alloys, and the preparation of lithium and lithium alloy anodes for lithium metal batteries. Selective coordination of lithium cations and other electroactive cations combined with liquid-liquid extraction provides a tool for such electrolytic purification processes. However, the commercial development of such processes is hindered by the strong affinity of electroactive cations in general and lithium cations in particular for water molecules.

### SUMMARY

According to embodiments of the disclosure, a system is disclosed for extracting a metal from an aqueous salt solution, the aqueous salt solution having dissolved therein a cation of the metal to be extracted. In such embodiments, the system includes a first chamber, containing an organic solution, the organic solution having dissolved therein a salt of an organic anion with a cation of the metal to be extracted, and a coordination compound configured to coordinate the cation of the metal to be extracted. The system further includes a second chamber, containing the aqueous salt solution. Additionally, the system includes a cathode, disposed in the first chamber, an anode, disposed in the second chamber, a first membrane interposed between the organic solution in the first chamber, the aqueous salt solution in the second chamber, and a means for removing water molecules from the organic solution, wherein the cation of the metal to be extracted traverses the first membrane from the aqueous salt solution to the organic solution as voltage is applied.

In an embodiment, the metal to be extracted is lithium, the organic solution includes a salt of lithium with an organic anion, and the coordination compound is a lithium cation coordination compound that selectively coordinates lithium cation compared to other cations. In this embodiment, the aqueous salt solution includes an aqueous lithium salt solution.

In some embodiments, the first chamber is divided into a first sub-chamber and a second sub-chamber, the first sub-chamber containing the cathode, and a first portion of the organic solution, the second sub-chamber containing a second portion of the organic solution, and further comprising a second membrane interposed between the first sub-chamber and the second sub-chamber the second membrane being permeable to the metal cation. In such embodiments, the second portion of the organic solution in the second sub-chamber is in contact with the first membrane. In some such embodiments, the means for removing water molecules is disposed in the second sub-chamber. In some embodiments, the second membrane is a metal organic framework (MOF), the MOF being capable of absorbing water molecules. In some such embodiments the MOF is copper benzene-1,3,4,-tricarboxylate (Cu₃(BTC)₂).

According to some embodiments, the means for removing water molecules from the organic solution includes a pair of electrodes, at least one of the electrodes of the pair being disposed in the organic solution and the other electrode of the pair being disposed in either the organic solution or in the aqueous salt solution. For such embodiments, as voltage is applied across the electrodes, water is electrolyzed to generate hydrogen and oxygen as gases. According to some embodiments, a solid substrate that absorbs water provides the means for removing water molecules from the organic solution. For some such embodiments, the solid substrate is a molecular sieve.

According to some embodiments, the means for removing water molecules from the organic solution is selected from the group consisting of (a) deposition at a temperature of between 60° C. and 180° C., (b) purging of the organic solution with dry argon gas, (c) applying a vacuum to the organic phase, and (d) combinations thereof.

According to some embodiments the one or more coordination compounds are selected from the group consisting of crown ethers, cryptands, orthoester cryptands, spherands, cryptashperands, hemisspherands, corands, podands, and combinations thereof. According to some embodiments, the lithium cation coordination compound is a crown ether selected from the group consisting of 14-crown-4, substituted derivatives of 14-crown-4, 12-crown-4, substituted derivatives of 12-crown-4, and combinations thereof. According to some embodiments, the organic lithium salt solution includes an anion with a chemical structure of (RS(O)₂)₂N⁻, where R is a substituent selected from the group of alkyl, perfluorinated alkyl, partially fluorinated alkyl, aryl, perfluorinated aryl, partially fluorinated aryl, and combinations thereof.

According to some embodiments, the organic solvent is selected from the group consisting of CH₃(CH₂)ₚOCH₂(CF₂)ₙCH₂O(CH₂)_{q}CH₃ (n=1-15, p=0-15, q=0-15), alkanes, and combinations thereof. According to some embodiments, the organic solvent is selected from the group consisting of a liquid polymer and an electrochemically stable ionic liquid.

According to some embodiments, a method is disclosed of extracting a metal from an aqueous salt solution containing a cation of the metal to be extracted, the method including the steps of:
(1) applying voltage across a cathode disposed in an organic solution comprising a salt of an organic anion with a cation of the metal to be extracted, and a coordination compound configured to coordinate the cation of the metal to be extracted, and an anode disposed in the aqueous salt, the aqueous salt solution comprising water and a water-soluble salt of the metal to be extracted;
(2) passing the cation of the metal to be extracted through a first membrane from the aqueous salt solution to the organic solution;
(3) coordinating the cation of the metal to be extracted with the coordination compound;
(4) removing from the organic solution water molecules that traverse the first membrane; and
(5) depositing the cation of the metal to be extracted on the cathode, thereby causing a layer of the metal to be deposited on the cathode.

In some embodiments, a further step is provided of removing the layer of the metal to be extracted from contact with the organic solution and cleaning a surface of the layer of one or more metals. In such embodiments, the cleaning may include contacting with an organic solvent, for example hexane or dimethyl carbonate. In some embodiments, contacting with an organic solvent includes operations selected from the group consisting of soaking, rinsing, and combinations thereof. In some embodiments, the cleaning may include brushing with a soft sponge, followed by sonication in the organic solvent.

According to some embodiments of the method, water is removed by one or more of absorbing water molecules, performing electrolysis to generate hydrogen and oxygen gases, and absorbing water molecules in a molecular sieve.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each publication, patent, or patent application was specifically and individually indicated to be incorporated by reference.

### BRIEF DESCRIPTION OF THE DRAWINGS

The foregoing features of embodiments will be more readily understood by reference to the following detailed description, taken with reference to the accompanying drawings, in which:

FIG. 1 outlines a series of steps for the electrolytic extraction of lithium ions from brine, transfer through a lithium-ion permeable membrane into an organic solution containing lithium salt and lithium coordination compound, removal of water molecules, and electroplating onto a cathode.

FIG. 2 provides an embodiment of the disclosed system for extracting one or more metals from brine. According to this embodiment, water is removed by water electrolysis wherein two electrodes are disposed in an organic solution.

FIG. 3 provides an embodiment of the disclosed system for extracting one or more metals from brine. According to this embodiment, water is removed by water electrolysis wherein one electrode is disposed in an organic solution and another electrode is disposed in the brine.

FIG. 4 provides an embodiment of the disclosed system wherein water is removed by trapping in water-absorbing materials such as a molecular sieve.

FIG. 5 embodies a system wherein water is removed by trapping in water-absorbing materials such as a molecular sieve, and wherein the water absorbing materials are stirred in order to speed up the absorption process.

FIG. 6 provides an embodiment of the disclosed system wherein water molecules are removed by capture as they flow into a metal organic framework (MOF).

### DETAILED DESCRIPTION

The field of supramolecular chemistry provides a menagerie of coordination compounds that form molecular “cages” that can envelop and bind a target chemical entity, often with a high degree of specificity. See Fabbrizzi, L. The origins of the coordination chemistry of alkali metal ions. ChemTexts 2020, 6(10) https://doi.org/10.1007/s40828-020-0107-2. See also Cram. The Design Of Molecular Hosts, Guests, And Their Complexes (Nobel lecture), Angewandte Chemie International Edition 1988, 27(8), 1009-1112. 9-Crown ethers are cyclic compounds containing several ether groups. Crown ethers have been developed as specific cages for alkali and alkaline earth compounds.

Among the alkali metals, lithium cation has the smallest ionic radius and the most negative hydration free energy (i.e. the strongest affinity for water molecules). Consequently, obtaining selectivity of a coordination compound for lithium ion in an aqueous solution compared to other metal cations may require a small cage, strict geometric constraints, and a minimal ability of the cage to rearrange its structure to accommodate larger cations.

A high degree of lithium selectivity was recently shown by crown ethers designed by Chung and colleagues at Myongji University in Korea. Chung, W.-J. et al., U.S. Pat. No. 9,850,226. Crown ethers have been used to concentrate lithium ions by liquid-liquid extraction and by membrane separation methods, including electrodialysis. He, L., et al., CN113293300; Wang, J., et al., CN110564965.

In the context of lithium batteries, crown ethers and other alkali cation complexing agents have been studied as a means to inhibit the formation of dendrites during repeated battery cycling. See e.g. Yu, Z., et al., Molecular Design for Electrolyte Solvents Enabling Energy-Dense and Long-Cycling Lithium Metal Batteries. Nat Energy 2020, 5 (7), 526-533.

Cryptands are polycyclic compounds that provide a versatile class of alkali and alkaline earth cation selective cage compounds and include nitrogen containing cryptands and orthoester cryptands. See Steed, J. W. First- and Second-Sphere Coordination Chemistry of Alkali Metal Crown Ether Complexes. Coordination Chemistry Reviews 2001, 215 (1), 171-221; see also Ldw, H. et al., Self-assembled orthoester cryptands: orthoester scope, postfunctionalization, kinetic locking and tunable degradation kinetics. Chem. Sci. 2018, 9, 4785-4793. Whereas crown ethers coordinate guest cations in a single ring, cryptands can “bury” ligands in bicyclic or polycyclic coordination complexes.

Spherands are a class of cryptands capable of highly symmetrical coordination of bound ligands. See Cram, D. J. et al., Host-Guest Complexation. 35. Spherands, the first completely preorganized ligand system. J. Am. Chem. Soc. 1985, 107, 3645-3657.

Without being bound to a particular theory, a distinct advantage of cryptands compared to crown ethers is that cryptands can occupy all inner sphere coordination sites on a metal cation, whereas crown ethers do not, meaning that for crown ethers some of these coordination sites will be occupied by water or other solvent molecules. Moreover, weaker outer sphere coordination of solvent molecules can potentially occur for any type of coordination complex. As a consequence, if coordination complexes are used for liquid-liquid extraction of active metal cations (e.g. lithium) from an aqueous solution into an organic solution, water will often be pulled along into the organic solution. The presence of such water is problematic for electrolytic processes in the organic solution involving electroplating of lithium metal as well as other electroactive metals.

### Methods

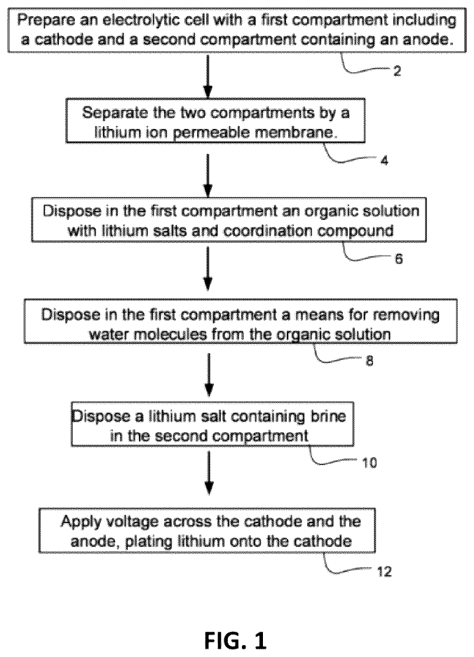

Referring to FIG. 1, the methods described herein drastically simplify the process of extracting an active metal from brine by electrodepositing the active metal onto a conductive substrate directly from brine. The present disclosure provides a method using lithium as an active metal. However, persons of ordinary skill in battery-related arts will understand that other active metals, including other alkali and alkaline earth metals, could equally well be extracted and electrodeposited by the described methods, and form part of the disclosed subject matter.

Extraction and electrodepositing are achieved by the following process:

An electrolytic cell with a first compartment and a second compartment is prepared with a conductive substrate functioning as a cathode disposed in the first compartment and an anode disposed in the second compartment 2. In the electrolytic cell, the two compartments are separated by a lithium ion permeable membrane 4. The first compartment may comprise an organic solution comprising lithium salts of organic anions and a lithium ion coordinating compound, such that the cathode is disposed in the organic solution 6. Also disposed in the first compartment is a means for removing water molecules from the organic solution 8. A lithium salt containing brine may be disposed in the second compartment, such that the anode is immersed in the brine 10. Voltage is applied across the cathode and the anode, plating lithium onto the cathode, at the same time any water that enters the first compartment is removed by the means for removing the water molecules 12.

As voltage is applied across an anode in the brine and a cathode comprising the conductive substrate, lithium ions move from the brine, through lithium ion permeable membrane, through the organic phase, and get deposited onto the surface of the conductive substrate, where they are reduced and electrodeposited.

The process of selectively transporting lithium through the organic liquid phase involves one or more coordination compounds present in the organic liquid phase. These compounds selectively coordinate lithium cations over other metal cations, thus dissolving the lithium cation in the organic liquid phase. Suitable coordination compounds comprise clathrates, which trap the lithium cation in a cage structure. Such clathrates comprise crown ethers and cryptands. In some embodiments, the cryptands are selected from the group consisting of cryptands containing nitrogen, orthoester cryptands, and spherands. The organic liquid phase further comprises a lithium cation with an organic anion that is soluble in the organic liquid phase but insoluble in the brine. During electrolysis, lithium ions are released from the coordination compounds and become electroplated onto the surface of the conductive substrate. To maintain charge neutrality, lithium ions are pulled from the brine to bind to the free coordination compounds that have released their lithium ion cargo. Due to the specificity of the coordination compounds for binding lithium, lithium is pulled into the brine preferentially compared to other cations.

In some embodiments, the selectivity of lithium ion transport is very high, leading to highly pure lithium being electroplated onto the surface of the conductive substrate. In some embodiments, the selectivity of lithium transport is reduced, leading to the electroplating of a lithium alloy. By varying the nature and amount of the one or more coordination compounds within the organic liquid phase, the lithium selectivity can be varied, so that other metal ions from the brine are transported and electroplated onto the conductive substrate in a controlled manner, allowing control over the composition of the electroplated lithium alloy.

### Crown Ethers and Cryptans

Crown ethers can selectively chelate metal ions that fit the size of the “crown.” Moreover, fine-tuning of pendant groups on the crown ethers allows control of their solubility in organic solvents. In particular, crown ethers can be optimized to make otherwise organic-solvent-insoluble inorganic salts soluble in organic solvents. The size of the crown but also the rigidity and steric hindrance can be tuned to achieve very high Li⁺ selectivity. See R. E. C. Torrejos et al. Chem. Eng. J. 2017, 326, 921. Such fine-tuned crown ethers show promise for the liquid-liquid extraction of Li⁺ from brine.

However, the roughly planar coordination sphere of a crown ether allows solvent molecules to coordinate to sites unoccupied by the crown ether. As a consequence of this coordination of solvent molecules, if a crown ether is used as a coordination compound, water molecules initially coordinated to a lithium cation may carry waters of hydration with them when they traverse the lithium ion permeable membrane. Such waters, if present at the cathode, can react with the electroplated lithium metal to form lithium hydroxide, leading to hydrogen gas evolution and degradation of the lithium layer.

In contrast to the coordination of crown ethers, cryptands may be able to more fully coordinate metal cations. In some embodiments, a cryptand forms a cage that is well-sized to selectively coordinate lithium ions.

The lithium-7 chemical shift for the coordination complex of lithium cation with a cryptand can largely be independent of solvent, demonstrating that the complex may not involve inner sphere coordination of solvent molecules. See Y. M. Cahen et al. J. Phys. Chem. 1975, 79, 1289.

As a consequence of the reduced coordination of water molecules, the use of cryptands provides one approach to reducing the amount of water that enters the first compartment of the electrolytic cell. However, even for cells using such cryptands, water can potentially enter the first compartment directly through the membrane or as part of the outer sphere coordination of lithium cations.

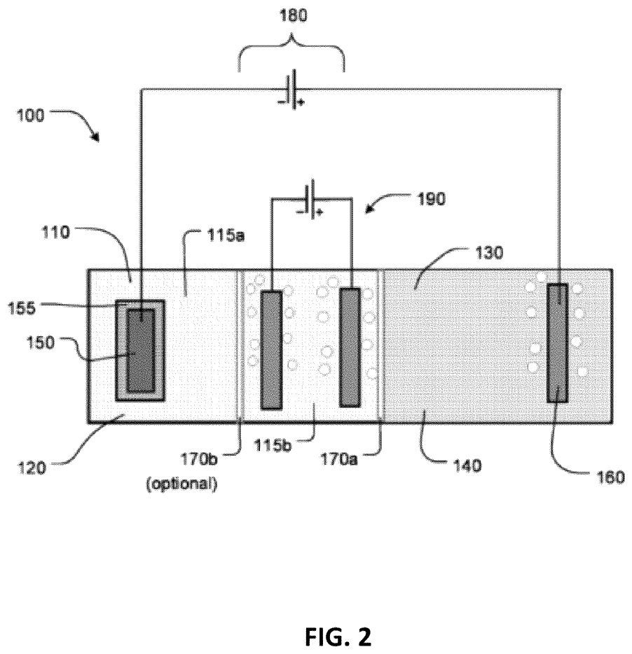

As disclosed in FIGS. 2-6, certain embodiments of the present disclosure can employ one or multiple means to remove water molecules that enter the first compartment of the electrolytic cell.

Common features of the embodiments of FIG. 2-6 comprise an electrolytic cell 100 with a first compartment 110 containing an organic solution 120 and a second compartment 130 containing an aqueous salt solution 140. A first lithium ion permeable membrane 170a separates the first compartment 110 from the second compartment 130. Disposed within the first compartment 110 may be a means of removing water molecules. Immersed in the organic solution 120 in the first compartment 110 may be a cathode 150, comprising a conductive substrate. Immersed in the aqueous salt solution 140 of the second compartment 130 may be an anode 160. The cathode 150 and the anode 160 may be connected by an external circuit configured to provide voltage 180 across the cathode 150 and the anode 160. According to some embodiments, the anode material comprises graphite or platinum. According to some embodiments, material making up the conductive substrate may be selected from the group consisting of copper, aluminum, graphite coated copper, nickel, stainless steel, platinum, gold, and metal alloys. In a preferred embodiment, the conductive substrate comprises copper.

The organic solution 120 comprises an organic solvent, a lithium ion coordination compound (cc), and an organic lithium salt (LiA), the organic lithium salt composed of an organic anion A⁻ and a lithium cation Li⁺. The organic solvent, the lithium ion coordination compound and the organic lithium salt may be immiscible in the aqueous salt solution 140. The lithium ion coordination compound may be primarily present as a lithium ion coordination complex, Li(cc)⁺. The aqueous salt solution 140 may be a brine comprising dissolved lithium cations, Li⁺(aq). In some embodiments, the aqueous salt solution 140 may be derived from seawater.

According to some embodiments, cc and Li⁺ may be present in the organic liquid phase in a 1:1 molar ratio, thereby forming a chelate, Li(cc)⁺, with the coordination compound. In some embodiments, A⁻ is (RSO₂)₂N⁻, denoted as RSI⁻ (bis(R-substituted sulfonyl)imide). In some such embodiments, R=—(CF₂)₃CF₃.

According to some embodiments, the organic solvent in the organic liquid phase may be CH₃OCH₂(CF₂)ₙCH₂OCH₃, where n=2-5. According to some embodiments, n=2, and the organic liquid phase may be FDMB (2,2,3,3-tetrafluoro-1,4-dimethoxylbutane). According to other embodiments the organic liquid phase may be FDMI (2,2,3,3,4,4,5,5-octafluoro-1,6-dimethoxyhexane).

According to some embodiments, the organic solvent in the organic liquid phase may be a solvent with a low vapor pressure. For some such embodiments, the low vapor pressure solvent may be a liquid polymer, for example low molecular weight polyethylene glycol. According to some embodiments the low vapor pressure solvent may be an electrochemically stable ionic liquid. For some such embodiments, the electrochemically stable ionic liquid may be chosen from the group consisting of N-methyl-N-propyl pyrrolidinium bis(fluorosulfonyl)imide), N-methyl-N-propyl pyrrolidinium bis(fluorosulfonyl)imide, 1-ethyl-3-methylimidazolium bis(fluorosulfonyl)imide, N,N-diethyl-N-(2-methoxyethyl)-N-methylammonium bis(trifluoromethanesulfonyl) imide, and combinations thereof.

According to some embodiments, the coordination compound may be a crown ether. In some embodiments, the coordination compound may be a cryptand. In some embodiments, the coordination compound may be selected from the group consisting of crown ethers, nitrogen-containing cryptands, orthoester cryptands, spherands, cryptashperands, hemisspherands, corands, podands, and combinations thereof. In some embodiments, the coordination compound may be a cryptand selected from the group consisting of a cryptand containing nitrogen, an orthoester cryptand, and a spherand.

According to some embodiments, the lithium ion selective coordination compound may be a crown ether having the chemical structure:

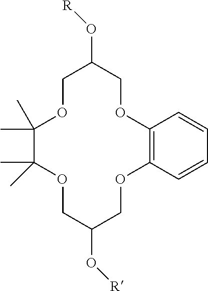

where R and R′ are pendant organic groups, modulating the solubility of the crown ether. According to some embodiments, R and R′ may be separately chosen from the group consisting of —(CH₂)ₘCH₃ and —(CF₂)ₚCF₃, where m=5-10 and p=0-10.

According to some such embodiments, the lithium ion selective crown ether may be selected from the group consisting of 14-crown-4, substituted derivatives of 14-crown-4, 12-crown-4, substituted derivatives of 12-crown-4, and combinations thereof.

Because the anion A⁻ of the lithium salt in the organic solution 120 may be hydrophobic, it remains confined to the organic solution 120 and does not migrate to the aqueous salt solution 140.

As embodied in FIGS. 2-6, as voltage 180 is applied across the anode 160 and the cathode 150, a layer of lithium metal 155 deposits on the surface of the conductive substrate according to the electrochemical reaction:

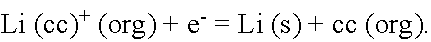

where “org” means the species is in the organic phase, and “s” means solid state species.

The empty coordination compound cc(org) then diffuses to the second lithium ion permeable membrane 170b separating the aqueous and organic phases to coordinate Li⁺ from the aqueous phase, thereby allowing lithium to enter the organic liquid phase as a crown ether complex:

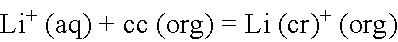

where “aq” means the species is in the aqueous phase (i.e. the aqueous solution of metal salts).

The lithium ion selectivity of the coordination compound ensures that lithium ion is preferentially coordinated compared to other metal cations in the aqueous solution of metal salts. Anions, such as Cl⁻ and SO₄²⁻, cannot enter the organic liquid phase either, because otherwise the charge neutrality of the organic phase would be violated. The net cathodic reaction is

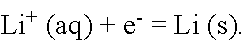

The anodic reaction depends on the composition of the aqueous solution of metal salts. If the anion is predominantly SO₄²⁻ and/or CO₃²⁻ the anodic reaction will be

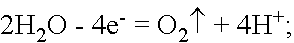

If the anion is predominantly Cl⁻, the following electrochemical reaction may also occur:

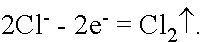

### Systems

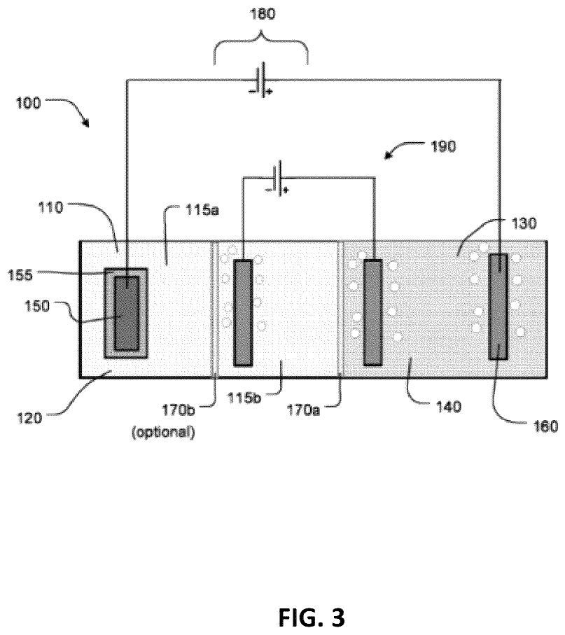

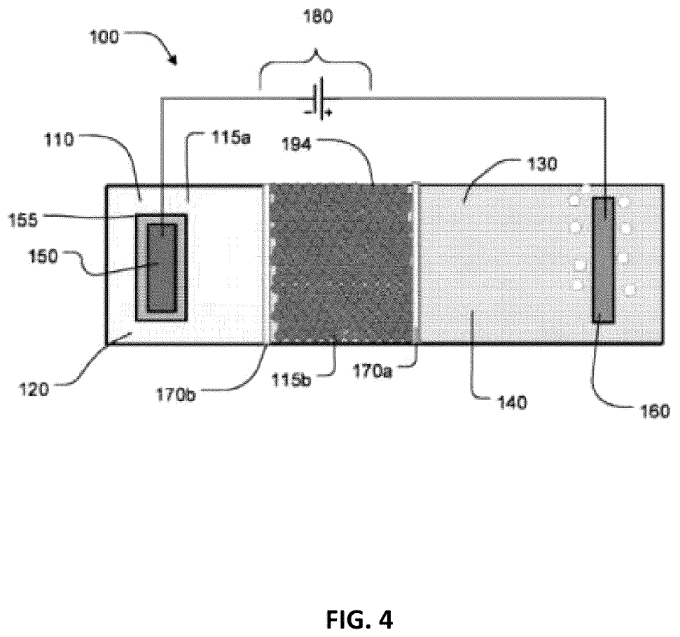

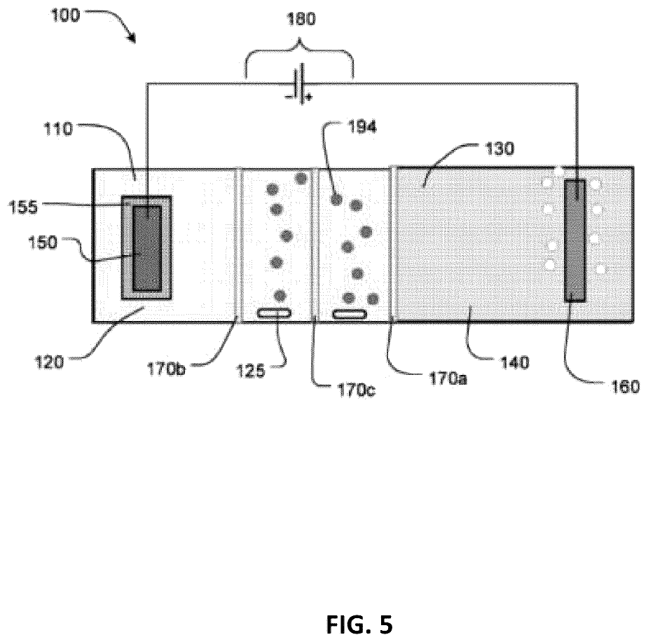

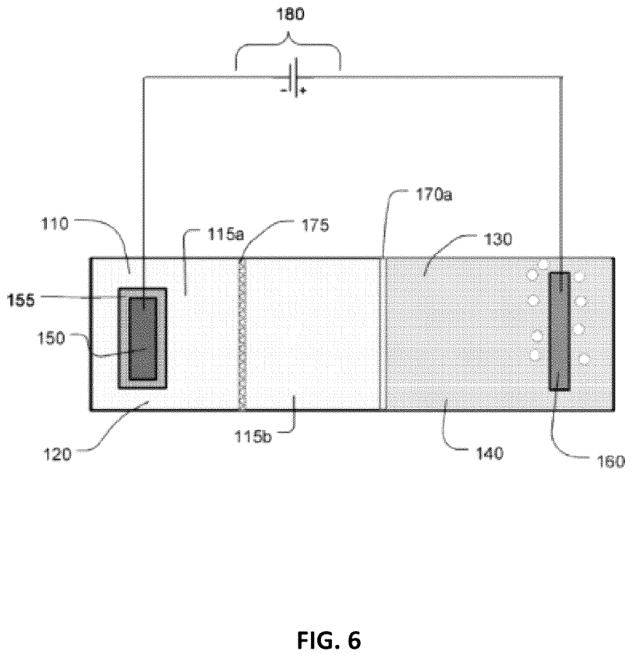

For the embodiments of FIGS. 4 and 6, and optionally for the embodiments of FIGS. 2 and 3, the first compartment 110 may be further divided into a first sub-compartment 115a and a second sub-compartment 115b, wherein the cathode may be disposed within the first sub-compartment 115a, wherein the second sub-compartment 115b may be disposed between the first sub-compartment 115a and the second compartment 130, and wherein a second lithium ion permeable membrane 170b separates the first sub-compartment 115a from the second sub-compartment 115b. For such embodiments, the means of removing water molecules may be disposed in whole or in part in the second sub-compartment 115b. In some embodiments, the sub-compartment 115b may be further divided into additional sub-compartments, the sub-compartments separated by additional lithium ion permeable membranes. For example, in the embodiment shown in FIG. 5, sub-compartment 115b may be separated into two sub-compartments (not labeled) by the lithium ion permeable membrane 170c.

In the embodiments of FIGS. 2 and 3, the means of removing water molecules may be by an electrolytic apparatus 190 comprising a pair of electrodes across which a voltage is applied that is sufficient to electrolyze water into hydrogen and oxygen but insufficient to reduce lithium ion to lithium metal. For the embodiment of FIG. 2, the pair of electrodes may be disposed in the first compartment. According to this embodiment, if the first compartment 110 is further divided into sub-compartments 115a, 115b, then the pair of electrodes may be disposed within the second sub-compartment 115b. For the embodiment of FIG. 3, one of the electrodes may be disposed in the aqueous salt solution of the second compartment and the other electrode may be disposed in the organic solution of the first compartment 110. For some embodiments of FIG. 2 and FIG. 3, adjustment of the voltage further allows the selective removal by electroplating of metal ion impurities that are less electropositive than Li⁺.

In the embodiment of FIG. 4, molecular sieves 194 provide the means of removing water molecules. According to this embodiment, the molecular sieves may be packed into the second sub-compartment 115b of the first compartment, confined between the first lithium ion permeable membrane 170a and the second lithium ion permeable membrane 170b.

The embodiment of FIG. 5 likewise uses molecular sieves as a means of removing water molecules. Here the molecular sieves 194 that are confined to the second sub-compartment 115b of the first compartment 110 may not be packed tightly but rather may be stirred in order to increase the rate of water molecule absorption. In some such embodiments, the stirring may be facilitated by one or more magnetic stir-bars 125. In some such embodiments, the second sub-compartment 115b of the first compartment 110 may be further divided in two, being separated by a third lithium ion permeable membrane 170c, creating two sub-sub-compartments, each of which includes stirred molecular sieves 194.

In the embodiment of FIG. 6, the second lithium ion permeable membrane may be a metal organic framework (MOF) 175, which functions both as the lithium ion permeable lattice and as the means to remove water molecules. The MOF 175 may be configured to trap water molecules in its lattice, but to allow lithium ions to pass between the first sub-compartment 115a and the second sub-compartment 115b. In some embodiments the MOF 175 may be copper benzene-1,3,4,-tricarboxylate (Cu₃(BTC)₂).

In some embodiments, the means of water removal may be selected from the group consisting of deposition at a high temperature (e.g. between 60° C. and 180° C.), application of a vacuum, bubbling with dry argon, and combinations thereof. In some embodiments, the high temperature is at least 60° C., 70° C., 80° C., 90° C., 100° C., 110° C., 120° C., 130° C., 140° C., 150° C., 160° C., 170° C., or 180° C. In some embodiments, the high temperature is at most 60° C., 70° C., 80° C., 90° C., 100° C., 110° C., 120° C., 130° C., 140° C., 150° C., 160° C., 170° C., or 180° C. In some embodiments, the high temperature is about 60° C. to 180° C., 70° C. to 170° C., 80° C. to 160° C., 90° C. to 150° C., 100° C. to 140° C., or 110° C. to 130° C. For such embodiments, the organic solvent in the organic liquid phase may be a solvent with a low vapor pressure. For some such embodiments, the organic liquid phase may be chosen as a solvent with a low vapor pressure. For example, the low vapor pressure solvent may be a liquid polymer, such as low molecular weight polyethylene glycol, or an electrochemically stable ionic liquid for example chosen from the group consisting of N-methyl-N-propyl pyrrolidinium bis(fluorosulfonyl)imide), N-methyl-N-propyl pyrrolidinium bis(fluorosulfonyl)imide, 1-ethyl-3-metirsrlimidazolium bis(fluorosulfonyl)imide, N,N-diethyl-N-(2-methoxyethyl)-N-methylammonium bis(trifluoromethanesulfonyl) imide, and combinations thereof.

In some embodiments more than one means of removing water molecules may be combined. For example, means involving high temperature, vacuum, dry argon bubbling, electrolysis, molecular sieves, and metal organic frameworks may be combined in any or all possible permutations.

According to some embodiments, the organic solution 120 in the first compartment 110 may be connected to a circulation system which circulates the organic solution 120 through an external means of water removal (not shown).

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range of format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” a number refers to that number plus or minus 10% of that number. The term “about” a range refers to that range minus 10% of its lowest value and plus 10% of its greatest value.

Unless defined otherwise, all technical and scientific terms used herein have the same meaning as is commonly understood by one of skill in the art to which this invention belongs.

As used in this description and the accompanying claims, the following terms shall have the meanings indicated, unless the context otherwise requires. The following terms are defined only within the context of this application, and is not intended to provide a universal definition for such terms:

In the context of this application, a “conductive substrate” is an electrically conductive material that can function as a cathode in an electrolytic cell.

In the context of this application, a “lithium ion coordination compound” is a compound capable of selectively coordinating lithium ions compared to other cations.

An aqueous salt solution is a solution composed primarily of water, with salts dissolved therein.

The term “an aqueous metal salt solution” refers to a solution composed of mainly water with salts of metal, to be extracted, dissolved therein.

In the context of this application, the terms “brine,” “an aqueous salt solution,” “an aqueous metal salt solution,” and “an aqueous solution of metal salts” are used interchangeably.

In the context of this application, to “chelate” is synonymous with “coordinate” and means to bind a cation employing a “coordination compound.”

Lithium metal electrodes for lithium metal batteries comprise a thin layer (usually <50 μm thick) of lithium metal on a conductive substrate. The current state-of-the-art process for manufacturing lithium metal electrodes from brine takes multiple steps, including purification of brine, electrolysis of molten LiCl, and extrusion of Li ingots into thin films on copper.

### LIST OF EMBODIMENTS

The following list of embodiments of the invention are to be considered as disclosing various features of the invention, which features can be considered to be specific to the particular embodiment under which they are discussed, or which are combinable with the various other features as listed in other embodiments. Thus, simply because a feature is discussed under one particular embodiment does not necessarily limit the use of that feature to that embodiment.

Embodiment 1. A system for extracting a metal from an aqueous salt solution, the system comprising:
a first chamber, containing an organic solution, the organic solution comprising a salt of an organic anion with a cation of the metal, and a coordination compound configured to coordinate the cation of the metal;
a second chamber, containing the aqueous salt solution, the aqueous salt solution having dissolved therein a water soluble salt of the metal;
a cathode, disposed in the first chamber;
an anode, disposed in the second chamber;
a first membrane interposed between the organic solution in the first chamber and the aqueous salt solution in the second chamber, wherein the cation of the metal traverses the first membrane from the aqueous salt solution to the organic solution as voltage is applied; and
means for removing water molecules from the organic solution.

Embodiment 2. The system for extracting a metal from an aqueous salt solution according to embodiment 1, wherein the metal comprises lithium, the organic solution comprises a salt of lithium with an organic anion, and the coordination compound comprises a lithium cation coordination compound that selectively coordinates lithium cation compared to other cations.

Embodiment 3. The system for extracting a metal from an aqueous salt solution according to embodiments 1 or 2, wherein the first chamber is divided into a first sub-chamber and a second sub-chamber, the first sub-chamber containing the cathode, and a first portion of the organic solution, the second sub-chamber containing a second portion of the organic solution, and further comprising a second membrane interposed between the first sub-chamber and the second sub-chamber the second membrane being permeable to the metal cation and wherein the second portion of the organic solution in the second sub-chamber is in contact with the first membrane.

Embodiment 4. The system for extracting a metal from an aqueous salt solution according to embodiment 3, wherein the means for removing water molecules is disposed in the second sub-chamber.

Embodiment 5. The system for extracting a metal from an aqueous salt solution according to embodiment 3, wherein the means for removing water molecules comprises the second membrane and wherein the second membrane is a metal organic framework (MOF), the MOF being capable of absorbing water molecules.

Embodiment 6. The system for extracting a metal from an aqueous salt solution according to embodiment 5, wherein the MOF is copper benzene-1,3,4,-tricarboxylate (Cu₃(BTC)₂).

Embodiment 7. The system for extracting a metal from an aqueous salt solution according to any of embodiments 1 to 4, wherein the means for removing water molecules from the organic solution includes a pair of electrodes across which when a voltage is supplied, water is electrolyzed to generate hydrogen and oxygen as gases, wherein at least one of the electrodes of the pair of electrodes is disposed in the organic solution, and wherein another electrode of the pair of electrodes is disposed in either the organic solution or in the aqueous solution.

Embodiment 8. The system for extracting a metal from an aqueous salt solution according to embodiment 7, wherein the pair of electrodes are configured such that adjustment of the voltage further allows a selective removal by electroplating of metal ion impurities that are less electropositive than Li⁺.

Embodiment 9. The system for extracting a metal from an aqueous salt solution according to any of embodiments 1 to 4, wherein the means for removing water molecules from the organic solution comprises a solid substrate that absorbs water.

Embodiment 10. The system for extracting a metal from an aqueous salt solution according to embodiment 8, wherein the solid substrate is a molecular sieve.

Embodiment 11. The system for extracting a metal from an aqueous salt solution according to any of embodiments 1 to 4, wherein the means for removing water molecules from the organic solution is selected from the group consisting of (a) deposition at a temperature of between 60° C. and 180° C., (b) purging of the organic solution with dry argon gas, (c) applying a vacuum to the organic phase, and (d) combinations thereof.

Embodiment 12. The system for extracting a metal from an aqueous salt solution according to any of embodiments 1 to 9, wherein the one or more coordination compounds are selected from the group consisting of crown ethers, cryptands, orthoester cryptands, spherands, cryptashperands, hemisspherands, corands, podands, and combinations thereof

Embodiment 13. The system for extracting a metal from an aqueous salt solution according to embodiment 2, wherein the lithium cation coordination compound is a crown ether.

Embodiment 14. The system for extracting a metal from an aqueous salt solution according to embodiment 2, wherein the lithium cation coordination compound is a cryptand.

Embodiment 15. The system for extracting a metal from an aqueous salt solution according to embodiment 2, wherein the lithium cation coordination compound is an orthoester cryptand.

Embodiment 16. The system for extracting a metal from an aqueous salt solution according to embodiment 2, wherein the lithium cation coordination compound is a crown ether selected from the group consisting of 14-crown-4, substituted derivatives of 14-crown-4, 12-crown-4, substituted derivatives of 12-crown-4, and combinations thereof.

Embodiment 17. The system for extracting a metal from an aqueous salt solution according to embodiment 2, wherein the aqueous lithium salt solution comprises an anion with a chemical structure of (RS(O)₂)₂N—, where R is a substituent selected from the group consisting of alkyl, perfluorinated alkyl, partially fluorinated alkyl, aryl, perfluorinated aryl, partially fluorinated aryl, and combinations thereof.

Embodiment 18. The system for extracting a metal from an aqueous salt solution according to any of embodiments 1 to 16, wherein the organic solvent is selected from the group consisting of CH₃(CH₂)ₚOCH₂(CF₂)ₙCH₂O(CH₂)_{q}CH₃ (n=1-15, p=0-15, q=0-15), alkanes, and combinations thereof.

Embodiment 19. The system for extracting a metal from an aqueous salt solution according to any of embodiments 1 to 16, wherein the organic solvent is selected from the group consisting of a liquid polymer and an electrochemically stable ionic liquid.

Embodiment 20. A method of extracting a metal from an aqueous solution of metal salts containing a cation of the metal to be extracted, comprising:
applying voltage across (i) a cathode disposed in an organic solution comprising a salt of an organic anion with a cation of the metal to be extracted, and a coordination compound configured to coordinate the cation of the metal to be extracted, and (ii) an anode disposed in the aqueous solution of metal salts, the aqueous solution of metal salts comprising water and a water soluble salt of the metal to be extracted;
passing the cation of the metal to be extracted through a first membrane from the aqueous solution of metal salts to the organic solution;
coordinating the cation of the metal to be extracted with the coordination compound;
removing from the organic solution water molecules that traverse the first membrane; and
depositing the cation of the metal to be extracted on the cathode, thereby causing a layer of the metal to be deposited on the cathode.

Embodiment 21. The method of embodiment 20, further comprising
removing the layer of the metal to be extracted from contact with the organic solution and cleaning a surface of the layer of one or more metals.

Embodiment 22. The method of embodiment 20, wherein the cleaning includes contacting with an organic solvent.

Embodiment 23. The method of embodiment 20, wherein the organic solvent is hexane or dimethyl carbonate.

Embodiment 24. The method of embodiment 20, wherein contacting with an organic solvent includes operations selected from the group consisting of soaking, rinsing, and combinations thereof.

Embodiment 25. The method of embodiment 20, wherein the cleaning includes brushing with a soft sponge and sonication in the organic solvent.

Embodiment 26. The method of embodiment 20, wherein the removing comprises absorbing the water molecules in a metal organic framework.

Embodiment 27. The method of embodiment 19, wherein the removing comprises performing electrolysis to generate hydrogen and oxygen gases.

Embodiment 28. The method of claim 20, wherein the removing comprises absorbing the water molecules in a molecular sieve.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

1. A system for extracting a metal from an aqueous metal salt solution, the system comprising:
(i) a first chamber comprising an organic solution,
wherein the organic solution comprises a salt of an anion with a metal cation, and one or more coordination compounds configured to coordinate the metal cation;
(ii) a second chamber comprising the aqueous metal salt solution; and
(iii) a first membrane interposed between the organic solution in the first chamber and the aqueous metal salt solution in the second chamber,
wherein the metal cation traverses the first membrane from the aqueous metal salt solution to the organic solution as voltage is applied;
wherein the system is configured to remove water molecules from the organic solution.

2. The system of claim 1, wherein the metal cation comprises a lithium ion.

3. The system of claim 1, wherein the organic solution comprises a lithium salt with an organic anion, and wherein the coordination compound comprises a lithium cation coordination compound that selectively coordinates lithium cation.

4. The system of claim 1, further comprising a cathode positioned in the first chamber.

5. The system of claim 1, further comprising an anode positioned in the second chamber.

6. The system of claim 1, wherein the first chamber is divided into a first sub-chamber and a second sub-chamber, wherein the first sub-chamber comprises the cathode and a first portion of the organic solution, and wherein the second sub-chamber comprises a second portion of the organic solution in contact with the first membrane.

7. The system of claim 1, wherein the first chamber further comprises a second membrane interposed between the first sub-chamber and the second sub-chamber.

8. The system of claim 1, wherein the second membrane is permeable to the metal cation.

9. The system of claim 1, wherein the second membrane comprises a metal organic framework (MOF), wherein the MOF is capable of absorbing water molecules.

10. The system of claim 1, wherein the MOF is comprises copper benzene-1,3,4,-tricarboxylate (Cu₃(BTC)₂).

11. The system of claim 1, further comprising a pair of electrodes, wherein a voltage applied across the pair of electrodes results in electrolysis of water to produce hydrogen gas and oxygen gas, wherein at least one electrode of the pair of electrodes is positioned in the organic solution, and another electrode of the pair of electrodes is positioned in either the organic solution or the aqueous metal salt solution.

12. The system of claim 11, wherein the voltage applied across the pair of electrodes is further adjusted to selectively electroplate metal ion impurities less electropositive than Li⁺.

13. The system of claim 1, further comprising a solid substrate absorbing water.

14. The system of claim 13, wherein the solid substrate comprises a molecular sieve.

15. The system of claim 1, wherein the system is configured to remove water molecules from the organic solution by performing at least one of (a) depositing the metal cation at a temperature of between 60° C. and 180° C., (b) purging of the organic solution with dry argon gas, (c) applying a vacuum to the organic solution, and (d) a combination thereof.

16. The system of claim 1, wherein the one or more coordination compounds are selected from the group consisting of crown ethers, cryptands, orthoester cryptands, spherands, cryptashperands, hemisspherands, corands, podands, and a combination thereof.

17. The system of claim 3, wherein the lithium cation coordination compound is a crown ether selected from the group consisting of 14-crown-4, substituted derivatives of 14-crown-4, 12-crown-4, substituted derivatives of 12-crown-4, and a combination thereof.

18. (canceled)

19. The system of claim 3, wherein the lithium cation coordination compound is a cryptand comprising an orthoester cryptand.

20. (canceled)

21. The system of claim 1, wherein the aqueous metal salt solution comprising lithium salt comprises an anion with a chemical structure of (RS(O)₂)₂N⁻, where R is a substituent selected from the group consisting of alkyl, perfluorinated alkyl, partially fluorinated alkyl, aryl, perfluorinated aryl, partially fluorinated aryl, and a combination thereof.

22. The system of claim 1, wherein the organic solution is (i) a liquid polymer or an electrochemically stable ionic liquid or (ii) selected from the group consisting of CH₃(CH₂)ₚOCH₂(CF₂)ₙCH₂O(CH₂)_{q}CH₃ (n=1-15, p=0-15, q=0-15), alkanes, and a combination thereof.

23.-32. (canceled)
